(19) United States
(12) Patent Application Publication
(10) Pub. No.: US 2007/0256113 A1
(43) Pub. Date: Nov. 1, 2007

(54) Methods and devices for accessing content

(76) Inventors: Jairo Orlando Esteban, Freehold, NJ (US); Robert Michael Arlein, Maplewood, NJ (US); James Robert Ensor, Red Bank, NJ (US); Markus Andreas Hofmann, Fair Haven, NJ (US)

Correspondence Address: CAPITOL PATENT & TRADEMARK LAW FIRM, PLLC;ATTN: JOHN CURTIN, P.O. BOX 1995, VIENNA, VA, 22183, US

(21) Appl. No.: 11/412,828

(22) Filed: Apr. 28, 2006

(51) Int. Cl. H04N 7/16; H04N 7/18; H04N 7/20

(52) U.S. Cl. 725/139; 725/81; 725/135; 725/63

(57) ABSTRACT

A user's favorite sources of content are monitored and when such a source generates a content stream of interest, it may be forwarded to the user. If the forwarding of the stream is interrupted, content transmitted during the period of the interruption will not be lost because it can be subsequently accessed by the user at a location, for example, last accessed by the user before the interruption occurred.

### BACKGROUND OF THE INVENTION

Historically, a specific type of device was used to receive information (referred to herein as “content”). Similarly, a specific type of device or network was used to deliver, transmit or broadcast the content. For example, one type of content such as a live sporting event, news event or entertainment event would typically be broadcast using television transmission equipment so that they could be received by television sets. Similarly, the audio portion of these events may have been broadcast using radio transmission equipment so that they could be received by radios. In addition to content that was intended to be broadcast to many individuals, there also developed content that was intended to be received by only a single individual or very few individuals. Examples of this content are telephone calls, facsimile messages, e-mail messages and the like. Originally, this type of content was sent from one individual to another over networks operated by telephone companies and data service providers (collectively, referred to as “service providers”). Still, these types of communications and their respective content were originally received by specific devices. That is, telephone calls were received by telephones, facsimiles by fax machines and e-mails by a computer or the like.

Recently, however, manufacturers have developed so called “multimedia devices”. A multimedia device is one that is capable of receiving many different types of content (“multimedia” or “media” for short) instead of one specific type of content. For example, a wireless telephone may be capable of receiving voice-based telephone calls, e-mail and event broadcasts. As multimedia devices have been introduced, the service providers responsible for transporting content to users of these devices have had to modify their existing networks or install new networks in order to assure that they are capable of delivering different types of content to a single multimedia device.

Service providers are now increasingly studying the types of services they may provide to users of multimedia devices. For example, users are increasingly asking their service providers to give them access to all of the different types of content they are interested in, from any one of their communication devices (multimedia or not), whenever content-of-interest becomes available. As an example of this, suppose a user is interested in a particular song, so much so that the user wishes to receive the song whenever it is being broadcast. To meet such a desire, service providers need to develop services that can determine a user's content-of-interest and are capable of providing such content in a flexible and timely fashion.

A flexible service would allow users to switch from one content stream to another. Further, it would allow users to switch back to a first content stream and access any content from the first stream that they may have missed during the time they were accessing a second stream. Such a service should have the capability of storing or caching content from the first stream to ensure the user does not miss any content. In sum, it is desirable to provide methods and devices which allow users to access content in a highly flexible and reliable fashion.

### SUMMARY OF THE INVENTION

The present inventors have discovered methods and devices that allow content to be accessed in a flexible and reliable manner.

In one embodiment of the present invention, one method first comprises accessing a first content stream. If an interruption occurs (e.g., the user voluntarily or involuntarily switches to a second stream) the method further provides for a means to access a second content stream and then, subsequently, access content at any location in the interrupted, first content stream. By so doing, content that was transmitted during the interruption is not “lost” and may be subsequently accessed. This allows a user who was originally listening to, or viewing, the first content stream to once again listen to, or view, the content that was transmitted during the interruption

The accessing and subsequent accessing of content may be carried out by a user operating a multimedia device, such as a wired or wireless telephone, personal digital assistant (PDA), computer, gaming device, or the like.

In addition the present invention also provides methods and devices for controlling the forwarding of a first content stream so that, for example, a loss of content will not occur. In such an exemplary method an interruption event may be detected by one or more components of the service provider's network. Upon detection of the event the first content stream is prevented from being further forwarded until the cause of the interruption disappears or until a component of the network detects an event indicating that forwarding may resume. Once forwarding resumes, it may begin from any location in the content stream. This assures that any content that may have been transmitted during the period of the interruption may now be forwarded. In this manner, a user can receive all of the content she expected to originally receive.

These are just some of the examples of the present invention. Other examples are illustrated in the drawings and are set forth in the detailed description of the invention which follows.

### BRIEF DESCRIPTION OF THE DRAWINGS

FIG. 1 depicts an illustration of a network that includes one or more multimedia devices in accordance with one embodiment of the present invention.

FIG. 2 depicts an illustration of an interruption event.

### DETAILED DESCRIPTION OF THE INVENTION, WITH EXAMPLES

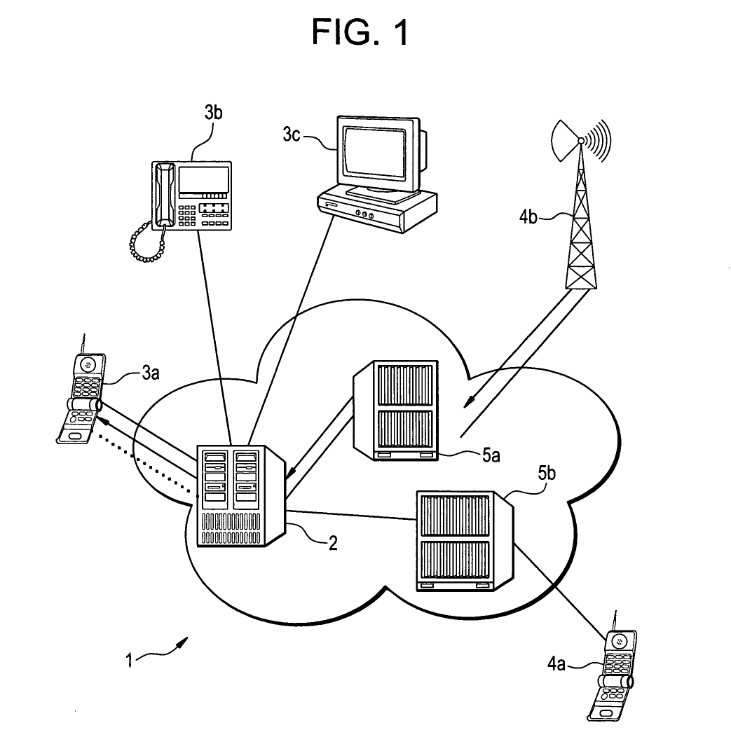

Referring now to FIG. 1, there is shown a network 1 which includes devices which operate in accordance with the present invention. As shown, the network 1 comprises of one or more devices 3a through 3c, at least one multimedia distribution and control device 2 (e.g., a server), one or more intermediate distribution devices 5a and 5b, and one or more sources of content 4a and 4b. To keep the explanation which follows as simple as possible, we will refer to the distribution and control device 2 as a “server”.

In accordance with the present invention, the server 2 is operable to control the transport and distribution of content to the devices 3a through 3c. More specifically, the server 2 controls the forwarding of content to the one or more devices 3a-c, content which the server 2 may receive directly from sources 4a, 4b or, via the intermediate content servers 5a, 5b or the like. It should be understood that while the server 2 is shown as a single component this may not always be the case. In alternative embodiments of the present invention, the server 2 may be separated into multiple components, each responsible for different or overlapping features and functions. The server 2 may comprise an Applications server that controls the transport and distribution of specific content. Further, the features and functions of the server 2 may be “distributed” throughout the network 1. That is, when the server is implemented as multiple components, each of the components may be installed at different locations throughout the network 1.

We will first present a discussion of the operation of an exemplary device 3a and then present a discussion of an exemplary server 2.

In embodiments of the present invention, each of the devices 3a-c may comprise a wired or wireless telephone, PDA, computer (laptop or desktop), gaming device or any other device which is capable of receiving and processing one or more forms of content. As shown in FIG. 1, device 3a is a wireless telephone, device 3b is a wired telephone and device 3c is a desktop computer. Each of the devices 3a-c may operate as follows.

At some instant of time, device 3a is powered-on and capable of receiving content. More specifically, the device 3a is ready to receive a telephone call, watch a video, play a game, or receive music to name just a few of the many different types of content that the device 3a may receive. For present purposes, we will also assume that the server 2 is in the process of forwarding content to the device 3a.

To access content, a user initially operates device 3a in accordance with instructions given by the manufacturer of device 3a. Thereafter, the device 3a may be operable to access a first content stream. By selecting a content stream, the device 3a is operable to access content in the selected stream (hereafter, the word “content” will mean information or the like selected from, or in, a content stream).

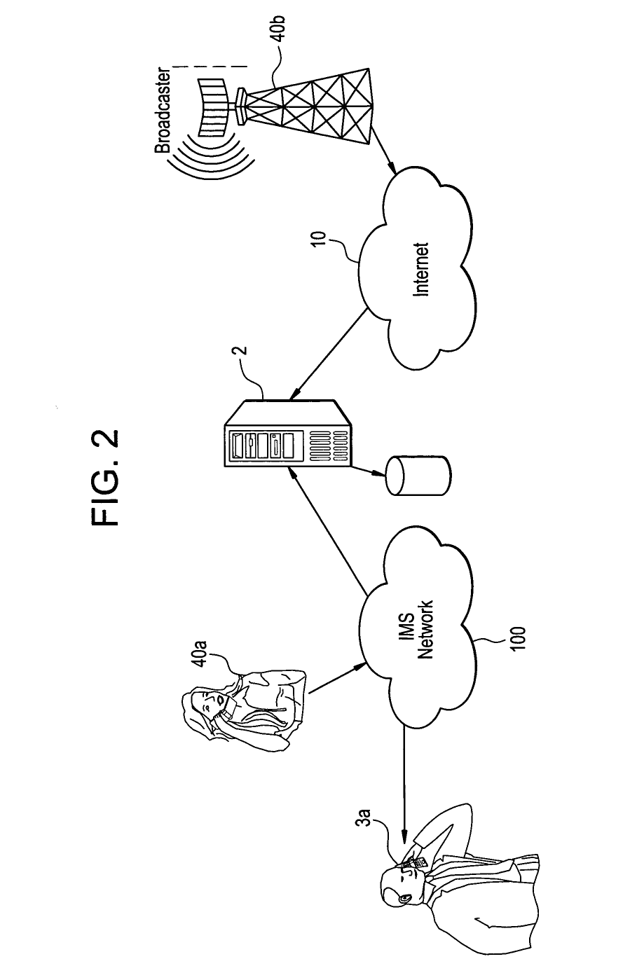

Referring now to FIG. 2 there is shown an example of a scenario where a user of device 3a accesses content being broadcast by a source 40b. As shown, the source 40b routes its broadcast through the Internet 10 and on to the server 2. While the example in FIG. 2 depicts content being routed via the Internet, this may or may not be necessary. That is, sometimes the content may be routed over other networks besides the Internet. Alternatively, content may be transported over so-called “ad hoc” networks or, still further, may be transported over something other than a formal network. In this first example, the server 2 forwards content it receives from the source 40b to the Internet 10 and then on to the end point device 3a via a second network 100, such as an IMS network. Thereafter, the user of device 3a operates the device 3a in order to listen to the broadcast, for example.

At some point in time, however, while the user of device 3a is accessing the first content stream, an event occurs which prompts the device 3a to switch content streams or otherwise prevents the user from accessing the first content stream. In either case, it can be said that the user's access to the first content stream is “interrupted”.

For example, if while the user is listening to the broadcast the user receives a telephone call from source 40a the user's access to content in the broadcast may be interrupted. In a further embodiment of the present invention, the device 3a and/or server 2 may be configured, programmed, designed or the like (collectively “configured”) to allow certain events to interrupt the user's access to a content stream. Similarly, they may be configured to ignore other events so that a user's access is not interrupted. In other instances, however, an interruption event may be triggered by something that is outside of the control of the user or network 1. For example, the device's 3a connection to the server 2 may be interrupted by physical phenomena, such as interference, fading and the like.

Regardless of the type of event that triggers the interruption, in accordance with one embodiment of the present invention, upon detection of the event the device 3a may be further operable to select a second content stream if one is available. In the example shown in FIG. 2, the device 3a is operable to select a second content stream that originates from the source 40a. In more detail, it is assumed that the source 40a has initiated a telephone call which is the event that triggered the interruption in the user's access to the first content stream (i.e., the broadcast). Upon selecting the telephone call as its second content stream the device 3a may access one or more channels within the selected content stream in order to carry out a conversation with whoever originated the telephone call. While a user of device 3a is accessing the second content stream, the first content stream may be stored by the server 2 and/or by the device 3a. A discussion of this storage capability is set forth in more detail below.

Assuming sometime thereafter that the user of the device 3a and a user of the device 40a end their telephone conversation, it is desirable to provide the user of device 3a with the ability to access all of the content from the first content stream which may have been transmitted during the time period when the user was speaking with the user of the device 40a (i.e., during the “interruption”). In accordance with the present invention, the device 3a may be further operable to subsequently access content at any location in the first content stream. It should be noted that the termination of the telephone call, in particular the signals associated with such a termination, may also be a type of “interruption” event because the signal interrupts the user's access to the second content stream.

By allowing the device 3a to access content at any location (e.g., time, point) in the first content stream the user is given the ability to choose at what point she wishes to once again receive and/or access the broadcast. That is, the present invention allows a user to access content that she has already received and accessed but wishes to “replay”, or content she has not already received/accessed. While the example above involves two content streams, it should be understood that the same principles of the invention apply to more than two content streams.

It should be further understood that the reception of a telephone call is just one type of event that may trigger an interruption in a user's access to a content stream. In general, this type of interruption may be classified as a “communication-related”, interruption event. Other communication-related events may also trigger an interruption. For example, the reception of a text or paging message, or the reception of another broadcast may also trigger an interruption. In general, the subsequent reception of any other content stream may trigger an interruption in the user/device's 3a access to previously received content streams. It should be noted that a communication-related event is an example of an event that is in the control of the user and or network 1.

Backtracking somewhat, it should also be understood that a device operating in accordance with the present invention comprises sufficient hardware, software and firmware to carry out the features and functions of the present invention. More specifically, a device may comprise one or more computer readable mediums (e.g., memory, processors, a combination of processors and memory, hard drives, compact disc) that may be operable to store one or more applications, such as software applications, that carry out the features and functions of the present invention. These applications in turn may be made up of code which manipulates and controls data and signals to enable the device to carry out the features and functions of the present invention.

Besides communication-related events, other events, such as “connectivity-related” events may trigger an interruption in a user's access to a content stream. For example, suppose the user of device 3a is moving and enters a region where a signal from network 1 is not capable of being received effectively. Perhaps the components making up network 1 or the components making up the device 3a are not sensitive enough to detect such a signal. Or, perhaps the signal being sent from the network 1 to device 3a is subject to interference that prevents it from being received properly. Either scenario may cause an interruption in the user's access to a first content stream. This is just some of the many examples of connectivity-related events. Another example is the termination of the telephone call discussed above. In general, connectivity-related events are not controlled by a user or network 1.

Even though her access has been interrupted, the present invention provides for means to allow the user to once again access the interrupted content stream. At some point in time the cause of the connectivity-related interruption may disappear or is otherwise compensated for by the network 1 or the device 3a (e.g., a user moves into an area that gets better reception or device 3a activates a compensation circuit). Suffice it to say that somehow the content stream is once again adequately received by the device 3a. When this occurs, in accordance with the present invention, the device 3a is operable to subsequently access content at any location in the content stream.

Because the user of device 3a is able to subsequently access content at any location in the content stream, the user is able to view, listen or otherwise access content that was transmitted by the source 40b during the interruption.

Communication-related and connectivity-related events are just two examples of events which may trigger an interruption in a device's access to a content stream. Another type of event is a “user selection” event. For example, the user of device 3a may interrupt her own access to a content stream by selecting features and functions of the device 3a. Upon selecting a feature or function, the user may activate commands which trigger an interruption in her access to one or more content streams.

Other types of events may also trigger an interruption. A device, such as device 3a, or another element of network 1 may be configured to generate “pre-determined” events which may trigger an interruption. For example, if the user of device 3a is listening to a broadcast from source 40b, the device 3a, server 2 or one of the other components shown in FIG. 1 may be configured to automatically switch to a second content stream at a particular point in the day so that the user will be able to view, listen or otherwise access content from this second content stream. Perhaps the user of device 3a wishes to listen to music on a different radio station, or the traffic or weather, for example, which may be broadcast at a certain time, or on a certain channel. These are just some of the numerous examples of pre-determined events which may trigger an interruption in the user/device 3a's access to a content stream.

Up until now we have focused our attention on the types of events which may trigger an interruption in a user's access to a content stream. After such an event has occurred, as indicated above, the user or device 3a may subsequently access content from the original or first content stream at any location in the content stream. It should be understood that by “subsequent access” to content or a content stream is meant access at any time after the event which triggers the interruption has been removed, disappears or is otherwise no longer affecting access to a previously received content stream.

In accordance with the present invention, when the user or device 3a subsequently accesses content in an interrupted content stream she may do so by selecting a given location within the content stream. For example, the device 3a may be operable to subsequently access content in a content stream that is located substantially close to content that was processed last before an interruption occurred.

Suppose the user was listening to a broadcast from source 40b when a triggering event occurs. Thereafter, the user subsequently accesses content and chooses to do so such that she accesses content at the point at which she last viewed, or listened to the broadcast. Though she may not know the exact point or location that she last viewed or listened to, she knows the approximate place. The device 3a is operable to select a location that is substantially close to the last location where content was processed by the device 3a before an interruption occurred. Alternatively, the device 3a may be operable to, through a command input by the user or by an external command, access content in the interrupted content stream that is located after content last processed before an interruption occurred. In this scenario the user or external command selects a point in the interrupted content stream that is after a point that was last viewed, listened to or otherwise accessed (collectively “processed”) by the user before the interruption occurred. Similarly, the device 3a may be operable to subsequently access content in the interrupted content stream that is located before content that was last processed before an interruption occurred.

In addition to giving a user the flexibility of selecting a location along the content stream, the present invention also provides the ability to incrementally select such a location. This and other features may, of course, be available to the user with or without an interruption. That said, in accordance with yet a further embodiment of the present invention this feature is available to a user after such an interruption occurs as well. This feature allows a user/device 3a to search through content located at various locations in the content stream in order to determine where she would like to once again begin viewing, listening to, etc., the interrupted content stream.

The features described above provide a user with the ability to rewind/reverse, fast forward or otherwise activate features that are similar to features offered by recording devices and the like. Further, the present invention provides the user/device 3a with the ability to access content at a plurality of locations in the content stream with or without the use of an incremental value. For example, the device 3a may be programmed or designed to skip from one location to another along the content stream where the difference between each location may or may not be the same incremental value. Again, this feature may help the user locate the last or next location she wishes to view or listen to content after an interruption occurs. This feature may also be used by the user even if no interruption occurs.

The content accessed may be real-time, stored or archived content to name just some of the examples of content which may be transmitted by the server 2 and accessed by the device 3a. By real-time content is meant content that is broadcast/transmitted and then received by device 3a with little or no time elapsing between the time the content is originally broadcast/transmitted and the time it is received by device 3a. This may occur when the broadcast/transmission is a live broadcast, for example. It may also occur when a broadcast/transmission is stored by its source and subsequently transmitted/broadcast.

In contrast, “stored” content refers to content which is stored by the server 2 or another component of the network 1, such as device 3a. The storage of content is triggered by the receipt of an interruption event by the device 3a or another component within the network 1. Further on in our discussion we will provide some examples of when a content stream and its content may be stored. Briefly, however, when a content stream is stored by the server 2 or another device within the network 1, it must be subsequently forwarded to the device 3a in order to be accessed by a user. Alternatively, if the content is stored by the device 3a the content must be subsequently retrieved from memory or the like so that it may be accessed by a user.

The third type of content/content stream mentioned above is an archived content stream. While an archived content stream is also stored, it is not stored in response to the detection of an interruption event. Instead by “archived content stream” is meant content or a content stream that has been stored sometime before the receipt of an interruption event and it is not necessarily related at all to such an event. For example, either the server 2, device 3a or another device within the network 1 may be operable to store content-of-interest to a particular user which the user desires to access in the future. Such examples are music, videos, e-mails or the like. This content may be stored for any length of time, for example, a number of weeks, months or years and still be accessible by the user and device 3a. Of course, if the content is archived the device which is storing the archived content (other than the device 3a itself) must forward that content onto the device 3a so that it may be received and accessed. When the archived content is stored by the device 3a it must be retrieved so that it may be subsequently accessed by its user.

Though a user may subsequently access content in, or from, a content stream very soon after an interruption event occurs, most likely some amount of time will pass. It can be said then that the version of the content or content stream which is subsequently accessed is a “delayed” version of an original content stream. Described as such, it can be said that the present invention provides methods and devices which allow for the subsequent access of content at any location in a delayed version of a content stream after an event triggers an interruption in access to the original content stream.

Similarly, in a situation where the user selects a second content stream when an interruption occurs to his access to a first content stream it can be said that the methods and devices provided by the present invention allow the user or device 3a to access content in the second content stream and then to later subsequently access content in a delayed version of the first content stream. That is to say, prior to subsequently accessing content in a delayed version of the first content stream, a user of device 3a may access one or more other content streams and the content therein.

When we first introduced FIG. 1 and the operation of device 3a we noted that the device 3a “selected” a content stream. In yet further embodiments of the invention, one or more content streams may be received and accessed by the user/device 3a without a selection step. That is, as described further below, the network 1, and in particular server 2, may be operable to monitor the type of content that is of interest to the user and when this content is available, or when the user has requested it be delivered (by pre-configurations, subscriptions, scheduling, for example), the server 2 may forward this content on to the device 3a. Thus, it can be said that the present invention also provides for the “pre-selection” of a content stream, which occurs without the execution of a selection step. It should be noted that while the server 2 is typically the device that does the pre-selection, this function may also be carried out by other elements of network 1, including the device 3a.

Up until now the examples we have given of the present invention have focused on the use of a single device. It may occur that a user has multiple devices which she can use to access content. For example, a user may use device 3a while she is moving from place to place but once she reaches a certain destination may thereafter prefer to use device 3b and/or 3c. Realizing this, the present invention provides for methods and devices that allow this to occur. In accordance with yet another embodiment of the present invention, a second device, such as device 3b or 3c, may be operable to select a previously selected content stream and access content at any location in the content stream. In this context, a “previously selected content stream” is a content stream that was being accessed by the user of device 3a prior to the time when she switched to another device such as device 3b or 3c. This switching of devices may also be viewed as another event which triggers an interruption. It can be referred to as a “device-triggered” interruption event. The locations within the content stream that may be accessed are the same as set forth above and need not be repeated here.

Having discussed the operation of user devices provided by the present invention, we now turn our attention to a discussion of the operation of the server 2 and other components within the network 1.

Referring back to FIG. 1, the server 2 may be operable to monitor the type of content accessed by a user as well as other habits related to the user's accessing of content (e.g., time of day the content is accessed, source of content, etc.,) in order to create and store a user profile. Of course, this monitoring is user-permitted through some type of agreement that sufficiently protects the privacy of the user. Upon creation of this profile, the server 2 or another element of network 1 may be further operable to update it based on habits of the user or instructions it receives from the user.

The server 2 may use this profile in order to determine what content to forward to a user. The forwarding may be triggered by a selection step initiated by the user, by pre-selection, an interruption of some kind, or other means. In accordance with the present invention, the server 2 is operable to forward a content stream to the user/device 3a in a manner that helps ensure that there is no “loss” of content.

In more detail, assume that the device 3a is already receiving content from a first content stream and thereafter an event, such as a communications-related, connectivity-related, user selection or a pre-determined event occurs. Such an event may be detected by the server 2, by intermediate devices between the server 2 and the source of the event, or by the device 3a. Regardless of how or where it is detected, eventually the detection of the event results in a signal being generated and sent to the server 2. Upon reception of such a signal, the server 2 may be operable to prevent the forwarding of content from the first content stream to the device 3a as long as it has not been configured to ignore such an event. In the example shown in FIG. 2, once the server 2 recognizes that a call has been placed to the device 3a, the server 2 is operable to prevent content from the first content stream (device 40b) from reaching the device 3a and triggers operations which allow the content from the second content stream (device 40a) to reach the device 3a.

After the server 2 has prevented the flow or forwarding of content from the first content stream to the device 3a the server 2 may be further operable to store content from the first content stream. In this manner, though the content is not forwarded to the device 3a it is nonetheless stored so that it may be subsequently accessed by the user (and forwarded by the server 2, etc.). It should be noted that, if desirable and possible, the stored content may be forwarded on to the device 3a a little bit at a time or according to some scheduling scheme even during a period of interruption. That is to say, provided that the device 3a has the storage capacity, the content which is stored by the server 2 may be sent to the device 3a while the device 3a is accessing another content stream, for example. In the scenario given in FIG. 2, server 2 stores the content from the first source 40b, a broadcast, until after the user of device 3a finishes her phone call with the user of source 40a.

In accordance with the present invention the server 2 may resume forwarding content, beginning with content from any location in the first content stream, upon detection of a resumption event.

A resumption event may be a signal which is sent by the device 3a to the server 2, or it may be the absence of a signal, such as the absence of a link between the source 40a and device 3a. In general, the resumption event indicates that the user of device 3a is no longer engaged in accessing content from another content stream or is no longer inhibited to receive content from the first content stream. Therefore, upon detection of this resumption event the server 2 recognizes that the device 3a is ready to once again receive and access content from the first content stream.

As explained above with respect to devices 3a-c, the ability to forward content starting from any location in the first content stream (or, in general, from any interrupted content stream) gives the user of device 3a the flexibility to resume accessing (e.g., viewing, listening, etc.) the first content stream at a location or at a point in time where the user last viewed, or listened to, content. In the context of FIG. 2, this gives the user of device 3a the ability to resume listening to, viewing or reading content from the original broadcast at a point she left off at.

As before, depending on how the device 3a or server 2 is configured, the server 2 may forward content in any number of ways. For example, content may be forwarded from a location in the content stream that is: (1) located substantially close to content that was processed last before an interruption event occurred; (2) from a location that is located after content that was processed last before an interruption event occurred; and (3) from a location that is located before content that was processed last before an interruption event occurred, to name just a few examples. Additionally, the forwarding may occur in increments. That is, content from different locations separated by a set incremental value (e.g., a set number of locations or a set amount of content) may also be used to forward content to the device 3a.

It should be understood that the content which is forwarded by the server 2 may be real-time, stored or archived content. In the case of real-time content, the server 2 may not be needed. That is to say no storage of the content may be carried out. Alternatively, if some delay is required the server 2 may temporarily store content that is sent from the source 40b, for example, and then send it on to the device 3a. In such a scenario, the delay will be very short and the device 3a will, practically speaking, receive the content from the source 40b as if there were no delay at all. When an interruption occurs or when some other signal is received, the server 2 may store the real-time content for subsequent forwarding to device 3a. In the case of archived content, this content may be stored within the server 2 for a relatively long period of time because it is only accessed on occasion by the device 3a. Even if it is only accessed occasionally, once the server 2 begins to forward archived content to the device 3a, it continues to do so until the server 2, device 3a or other element within network 100, for example, detects an interruption event. Viewed as such, there is no difference between real-time content and archived content in that both types of content may be forwarded to the device 3a until an interruption event occurred.

In the case where the user of device 3a selects content from a second content stream, the server 2 may be further operable to control the forwarding of content from this second content stream to the user of device 3a. Thereafter, upon the detection of a resumption event, the server 2 may once again forward content from the first content stream to the device 3a.

In sum, the server 2 may be operable to prevent the forwarding of content from a first content stream upon detection of an event and, thereafter, subsequently forward content from a delayed version of the first content stream, beginning with content from any location in the delayed content stream upon detection of a resumption event.

In the case where the user decides to switch devices, for example, from device 3a to device 3c, the server 2 may be operable to detect an interruption event based on a signal received from the device 3a via network 100, for example, and prevent forwarding of content to the device 3a. Initially, the server 2 may be operable to forward content, beginning with content from any location in the interrupted content stream, to the second device. This enables content from the first content stream to flow to the second device when it is selected by the user.

Our discussion of the server 2 has so far focused on the forwarding of content when an interruption event is detected. However, content may be forwarded by the server 2 or another element of network 1 regardless of whether or not such an event occurs. For example, in a further embodiment of the invention, the server 2 may create a profile that includes an indication of “pre-selected” content-of-interest to a user. By pre-selected is meant at least that content that the user has shown an interest in, or has received in the past. As a part of this embodiment, the server 2 may be operable to monitor a plurality of content sources, some of which generate content-of-interest to the user, such as baseball games played by the user's favorite team. In accordance with the present invention, the profile created may include an indication of the source of the baseball games (e.g., Internet address, company name) as well as the content itself. If during its monitoring the server 2 detects that a source is generating content-of-interest to a user (e.g., a baseball game), the server 2 may be further operable to obtain a copy or otherwise gain access to this content and, thereafter, forward the content to the user of device 3a in real-time or store/archive it for later access by the user. In general, the server 2 may forward pre-selected content-of-interest to the user and her device without prompting by the user and without the need to detect an interruption event. In fact, sometimes the device 3a may be powered on but not actively receiving any content so there is no interruption event, per se (though signals that “wake up” the device 3a may also be considered interruption events). In yet further embodiments, the content may be forwarded to the user in accordance with a schedule created by the user or network 1.

The discussion above has set forth some examples of the present invention. The true scope of the present invention, however, is given by the claims which follow.

We claim:

1. A method for accessing a content stream comprising:
accessing a first content stream sent via a network; and
subsequently accessing content at any location in the first content stream after an interruption event.

2. The method as in claim 1 further comprising accessing a second content stream prior to subsequently accessing the content in the first content stream.

3. The method as in claim 1 further comprising:
subsequently accessing content, at any location in a delayed version of the first content stream, after an interruption event.

4. The method as in claim 3 further comprising accessing one or more other content streams prior to subsequently accessing content in the delayed version of the first content stream.

5. The method as in claim 1 further comprising:
accessing a pre-selected content stream sent via a network; and
subsequently accessing content at any location in the pre-selected content stream.

6. A method for controlling the forwarding of a content stream comprising:
preventing the forwarding of a first content stream via a network upon detection of an event; and
subsequently forwarding the first content stream, beginning with content from any location in the content stream.

7. The method as in claim 6 further comprising storing content from the first content stream upon detection of the event.

8. The method as in claim 6 further comprising forwarding a second content stream prior to subsequently forwarding content from the first content stream.

9. The method as in claim 6 further comprising:
subsequently forwarding content from a delayed version of the first content stream, beginning with content from any location in the delayed content stream.

10. A method for forwarding a content stream comprising:
monitoring one or more pre-selected sources of content; and
forwarding a content stream from one of the sources via a network, wherein the content stream comprises content-of-interest to a user.

11. A device for accessing a content stream operable to:
access a first content stream sent via a network; and
subsequently access content at any location in the first content stream after an interruption event.

12. The device as in claim 11 further operable to access a second content stream prior to subsequently accessing content in the first content stream.

13. The device as in claim 11 further operable to:
subsequently access content, at any location in a delayed version of the first content stream, after an interruption event.

14. The device as in claim 13 further operable to access one or more other content streams prior to subsequently accessing content in the delayed version of the first content stream.

15. The device as in claim 11 further operable to:
access a pre-selected content stream sent via a network; and
subsequently access content at any location in the pre-selected content stream.

16. A device for controlling the forwarding of a content stream operable to:
prevent the forwarding of a first content stream via a network upon detection of an event; and
subsequently forward the first content stream, beginning with content from any location in the content stream.

17. The device as in claim 16 further operable to store content from the first content stream upon detection of the event.

18. The device as in claim 16 further operable to forward a second content stream prior to subsequently forwarding content from the first content stream.

19. A device for controlling the forwarding of a delayed content stream operable to:
prevent the forwarding of a first content stream via a network upon detection of an event; and
subsequently forward content from a delayed version of the first content stream, beginning with content from any location in the delayed content stream.

20. The device as in claim 19 further operable to:
monitor one or more pre-selected sources of content; and
forward a content stream via a network from one of the sources, wherein the content stream comprises content-of-interest to a user.
